(19) United States
(12) Patent Application Publication
(10) Pub. No.: US 2009/0252339 A1
(43) Pub. Date: Oct. 8, 2009

(54) SIGNAL PROCESSING DEVICE, SIGNAL PROCESSING METHOD, SIGNAL PROCESSING PROGRAM, AND COMPUTER READABLE RECORDING MEDIUM

(75) Inventors: Kensaku Obata, Saitama (JP); Yoshiki Ohta, Saitama (JP)

Correspondence Address: FOLEY AND LARDNER LLP;SUITE 500, 3000 K STREET NW, WASHINGTON, DC, 20007, US

(73) Assignee: Pioneer Corporation

(21) Appl. No.: 12/067,254

(22) PCT Filed: Sep. 20, 2006
(86) PCT No.: PCT/JP2006/318583

§ 371 Date: Mar. 18, 2008

(30) Foreign Application Priority Data
Sep. 22, 2005 (JP) 2005 275021

(51) Int. Cl. H04R 5/00

(52) U.S. Cl. 381/18

(57) ABSTRACT

In this signal processing apparatus, a first-audio-parameter calculating unit calculates a first audio parameter based on two audio signals. A second-audio-parameter calculating unit calculates a second audio parameter based on the two audio signals. A surround-signal generating unit generates surround components to be respectively allocated to surround signals.

### TECHNICAL FIELD

This invention relates to a signal processing apparatus, a signal processing method, a signal processing program, and a computer-readable recording medium that output an audio signal including surround signals. This invention is not limited to the above signal processing apparatus, signal processing method, signal processing program, and computer-readable recording medium.

### BACKGROUND ART

Conventionally, audio-signal playback apparatuses have been proposed that output audio signals input through L and R channels. One apparatus outputs audio signals through two channels. Another apparatus, in addition to L and R channels, uses a center (C) channel and surround channels, or a low frequency signal passed through a low pass filter to playback audio for a rich surround sound experience.

Another apparatus outputs two-channel input signals through 5.1 channels. Still another apparatus generates surround signals by extracting direction information from stereo signals (see, for example, Patent Document 1 below). With consideration of a mutual correlation, another apparatus generates surround signals based on a difference between a signal and an extracted signal of high correlation (see, for example, Patent Document 2 below).

[Patent Document 1] Published Japanese Patent Application No. 2004-504787

[Patent Document 2] Japanese Patent Application Laid-open Publication No. 2003-333698

### DISCLOSURE OF INVENTION

Problem to be Solved by the Invention

However, for input signals input through two channels, even when the signals are to be played back as surround signals, the input signals can only be played back in a form conforming to the signals input. Therefore, when the input signals are to be output as surround signals, the surround signals must be input together with the input signals, and in the case of playing back an expanding sound, playback is dependent on the input side.

When surround signals are generated by the addition and subtraction of signals through Lch and Rch channels, surround components (SL and SR) generated by the subtraction of the signals have inverse phases of each other due to the nature of the signal processing. Therefore, there is a problem in that the listener is enveloped in the inverse phases, causing an uncomfortable feeling.

Means for Solving Problem

A signal processing apparatus according to claim 1 includes: a first-audio-parameter calculating unit that calculates a first audio parameter based on two audio signals; a second-audio-parameter calculating unit that calculates a second audio parameter based on the two audio signals; and a surround-signal generating unit that generates surround components to be respectively assigned to surround signals based on a correlation between the first audio parameter and the second audio parameter.

A signal processing method according to claim 8 includes: a first-audio-parameter calculating step of calculating a first audio parameter based on two audio signals; a second-audio-parameter calculating step of calculating a second audio parameter based on the two audio signals; and a surround-signal generating step of generating surround components to be respectively assigned to surround signals based on a correlation between the first audio parameter and the second audio parameter.

Furthermore, a signal processing program according to claim 9 causes a computer to execute the signal processing method according to claim 8.

A computer-readable recording medium according to claim 10 stores therein the signal processing program according to claim 9.

### BRIEF DESCRIPTION OF DRAWINGS

FIG. 1 is a block diagram of a functional configuration of a signal processing apparatus according to an embodiment of the present invention;

FIG. 2 is a flowchart of a signal processing method according to the embodiment of the present invention;

FIG. 3 is a block diagram of a functional configuration of a signal processing apparatus of an example;

FIG. 4 is an explanatory diagram of mapping of a correlation value and a revel difference onto a two-dimensional plane;

FIG. 5 is an explanatory diagram of positions of a center signal and surround signals on the two-dimensional plane;

FIG. 6 is an explanatory diagram in a case in which each mapped point is arranged on the two-dimensional plane;

FIG. 7 is a flowchart of a process of generating surround signals based on the correlation value and the level difference;

FIG. 8 is an explanatory diagram of positions of each of surround channels on a coordinate system; and

FIG. 9 is an explanatory diagram of application to 7.1-channels.

### EXPLANATIONS OF LETTERS OR NUMERALS

101 first-audio-parameter calculating unit

102 second-audio-parameter calculating unit

103 surround-signal generating unit

301 correlation-value calculating unit

302 level-difference calculating unit

303 surround-component generating unit

304 adding unit

305 LPF

### BEST MODE(S) FOR CARRYING OUT THE INVENTION

Referring to the accompanying drawings, exemplary embodiments of the signal processing apparatus, the signal processing method, the signal processing program, and the computer-readable recording medium according to the present invention are explained in detail below.

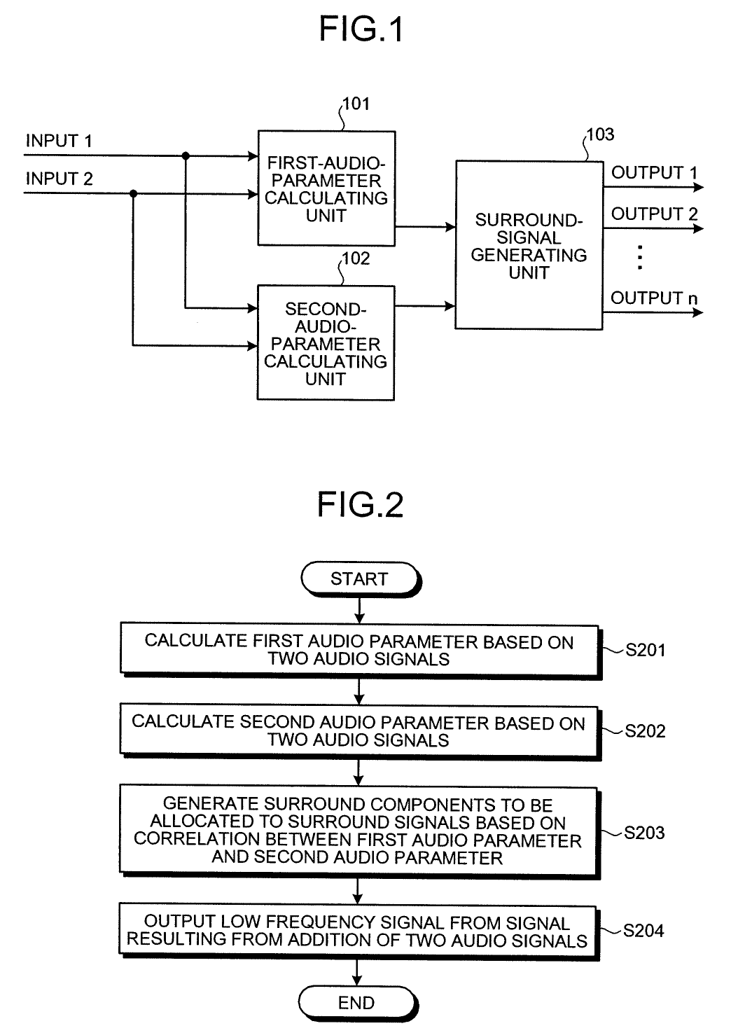

FIG. 1 is a block diagram of a functional configuration of a signal processing apparatus according to an embodiment of the present invention. The signal processing apparatus according to the embodiment includes a first-audio-parameter calculating unit 101, a second-audio-parameter calculating unit 102, and a surround-signal generating unit 103.

The first-audio-parameter calculating unit 101 calculates a first audio parameter based on two audio signals, for example, a first input 1 and a second input 2. The first-audio-parameter calculating unit 101 can calculate a correlation value between the two audio signals as the first audio parameter.

The second-audio-parameter calculating unit 102 calculates a second audio parameter based on the two audio signals, for example, a first input 1 and a second input 2. The second-audio-parameter calculating unit 102 can calculate a level difference between the two audio signals as the second audio parameter. In this case, the second-audio-parameter calculating unit 102 can calculate average levels of the two audio signals for each time window divided section, and regard a difference between the average levels as the level difference.

The first-audio-parameter calculating unit 101 and the second-audio-parameter calculating unit 102 can calculate, for each of the sections divided by time windows, the first audio parameter and the second audio parameter, respectively.

The surround-signal generating unit 103, according to the relationship between the first audio parameter and the second audio parameter, generates surround components to be allocated to surround signals. The surround-signal generating unit 103 can generate the surround components to be respectively allocated to the surround signals based on a distance between a position of the correlation between the first and the second audio parameters expressed on a coordinate system, and each position of the surround signals on the coordinate system.

The surround-signal generating unit 103 can generate, as the surround components, two surround signals and a center signal. When the surround components are not two, but more than two, the surround-signal generating unit 103 generates the surround components as an output 1, an output 2, . . . , and output n.

FIG. 2 is a flowchart of a signal processing method according to the embodiment of the present invention. Firstly, the first-audio-parameter calculating unit 101 calculates a first audio parameter based on the two audio signals (step S201). The first-audio-parameter calculating unit 101 can calculate a correlation value between the two audio signals.

The second-audio-parameter calculating unit 102 calculates a second audio parameter based on the two audio signals (step S202). The second-audio-parameter calculating unit 102 can calculate a level difference between the two audio signals as the second audio parameter. In this case, the second-audio-parameter calculating unit 102 can calculate average levels of the two audio signals for each of sections divided by time windows, and regard a difference between the average levels as the level difference.

The surround-signal generating unit 103 generates surround components to be allocated to surround signals (step S203). The surround-signal generating unit 103 can generate the surround components to be respectively allocated to the surround signals based on a distance between a position on a coordinate system representing a relationship between the first and the second audio parameters, and positions of the surround signals on the coordinate system. The surround-signal generating unit 103 can generate, as the surround components, two surround signals and a center signal. Then, the surround-signal generating unit 103 outputs a low frequency signal from a signal resulting from the addition of the two audio signals (step S204), and a series of the processing ends.

According to the embodiment explained above, two audio parameters can be calculated from two audio signals, and surround components to be allocated to the surround signals can be calculated from a correlation between the two audio parameters. The surround components can be calculated without the input of surround signals, and playback of an audio signal that includes a surround signal for a sound that is more natural causing no discomfort can be achieved.

### EXAMPLE

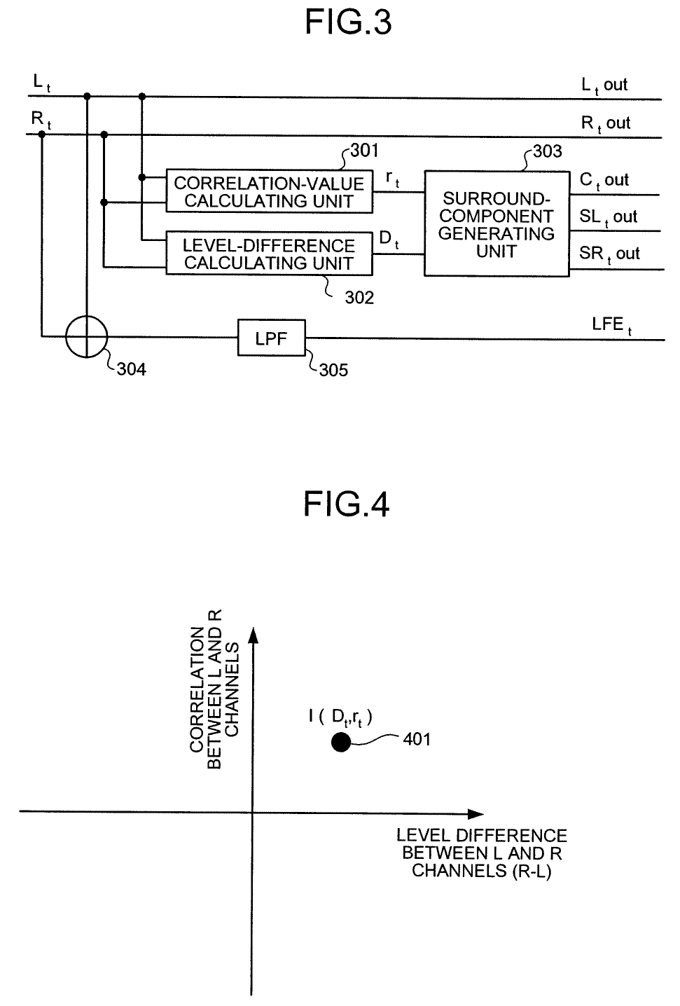

FIG. 3 is a block diagram of a functional configuration of a signal processing apparatus of an example. The signal processing apparatus includes a correlation-value calculating unit 301, a level-difference calculating unit 302, a surround-component generating unit 303, an adding unit 304, an LPF (low pass filter) 305. The signal processing apparatus generates 5.1-channel surround signals based on L and R channel stereo signals (L and R).

The signals (hereinafter, signals L and R) input to the signal processing apparatus are divided into signals each having a certain sample length to be processed at a predetermined interval. Hereinafter, two input signals Lₜ and Rₜ are input at a timeₜ. Accordingly, 5.1-channel surround signals Lₜout, Rₜout, Cₜout, SLₜout, SRₜout, and LFEₜ are generated.

The input signals Lₜ and Rₜ are input into the correlation-value calculating unit 301 and the level-difference calculating unit 302. The correlation-value calculating unit 301 calculates a value rₜ. The level-difference calculating unit 302 calculates a value Dₜ. The calculated values rₜ and Dₜ are output to the surround-component generating unit 303. The surround-component generating unit 303 generates the center component Cₜout, the surround signals SLₜout and SRₜout. The LPF 305 generates a signal LFEₜ based on the input signals Lₜ and the Rₜ added together by the adding unit 304. The signal LFEₜ is a low frequency signal for adding strength to the surround signals. Meanwhile, the input signals Lₜ and Rₜ are output as output signals Lₜout and Rₜout.

The correlation-value calculating unit 301 calculates a correlation value between the L and the R channel signals within a divided time interval. One method of calculating the correlation value is as follows. When the L and the R channel signals divided by the time windows (sample number N) are respectively Lₜ(i) and Rₜ(i), the correlation value between the L and the R signals is expressed by the following equation (1).

$$\begin{matrix}[ Equation 1 ] & \\ {r}_{t} = \frac{{\sum }_{i = 1}^{N} ( {L}_{t} ( i ) - \overline{{L}_{t}} ) ( {R}_{t} ( i ) - \overline{{R}_{t}} )}{\sqrt{{\sum }_{i = 1}^{N} {( {L}_{t} ( i ) - \overline{{L}_{t}} )}^{2}} \sqrt{{\sum }_{i = 1}^{N} {( {R}_{t} ( i ) - \overline{{R}_{t}} )}^{2}}} & ( 1 )\end{matrix}$$

The level-difference calculating unit 302 calculates average levels of the L and the R channel signals for each of the sections divided by the time windows, and subtracts the calculated averaged levels. The average level of the input signal Lₜ can be expressed by the following equation (2).

$$\begin{matrix}[ Equation 2 ] & \\ \overline{{pL}_{t}} = 20 {{log}_{10} ( \frac{1}{N} \sqrt{{\sum }_{i = 1}^{N} {{L}_{t} ( i )}^{2}} ) [ dB ]}^{T} & ( 2 )\end{matrix}$$

Furthermore, the average level of the input signal Rₜ can be expressed by the following equation (3).

$$\begin{matrix}[ Equation 3 ] & \\ \overline{{pR}_{t}} = 20 {{log}_{10} ( \frac{1}{N} \sqrt{{\sum }_{i = 1}^{N} {{R}_{t} ( i )}^{2}} ) [ dB ]}^{T} & ( 3 )\end{matrix}$$

Therefore, the level difference Dₜ can be calculated by the following equation (4).

Dₜ= p̅R̅ₜ̅− p̅L̅ₜ̅ [Equation 4]

Since the center component is a signal assigned to the center, when the center component is generated from the L and the R channel signals, there is no level difference between the L and the R channel signals. Therefore, only a component having a high correlation value is extracted as the center component. Additionally, a component having a low correlation value is extracted, as a surround component, from a signal without a designated orientation. As a result, more natural sounding surround signals causing no discomfort can be generated.

This signal processing apparatus calculates various audio properties useful for generating surround components, and with consideration of the properties, generates surround signals. Therefore, precision can be enhanced compared to a technique of generating surround signals using one parameter.

FIG. 4 is an explanatory diagram of mapping of the correlation value and the level difference onto a two-dimensional plane. Specifically, a point is mapped onto a plane in which a horizontal axis represents the level difference in units of decibels and a vertical axis represents the correlation value. The parameters calculated by the correlation-value calculating unit 301 and the level-difference calculating unit 302 are plotted along the axes.

The surround-component generating unit 303 maps rₜ and Dₜ respectively calculated by the correlation-value calculating unit 301 and the level-difference calculating unit 302 onto the two-dimensional plane. The surround-component generating unit 303 allocates the input signals Lₜ and Rₜ to surround components based on a coordinate on the plane. As a result, the rₜ and Dₜ are mapped onto a point 401 corresponding to a coordinate I (Dₜ, rₜ).

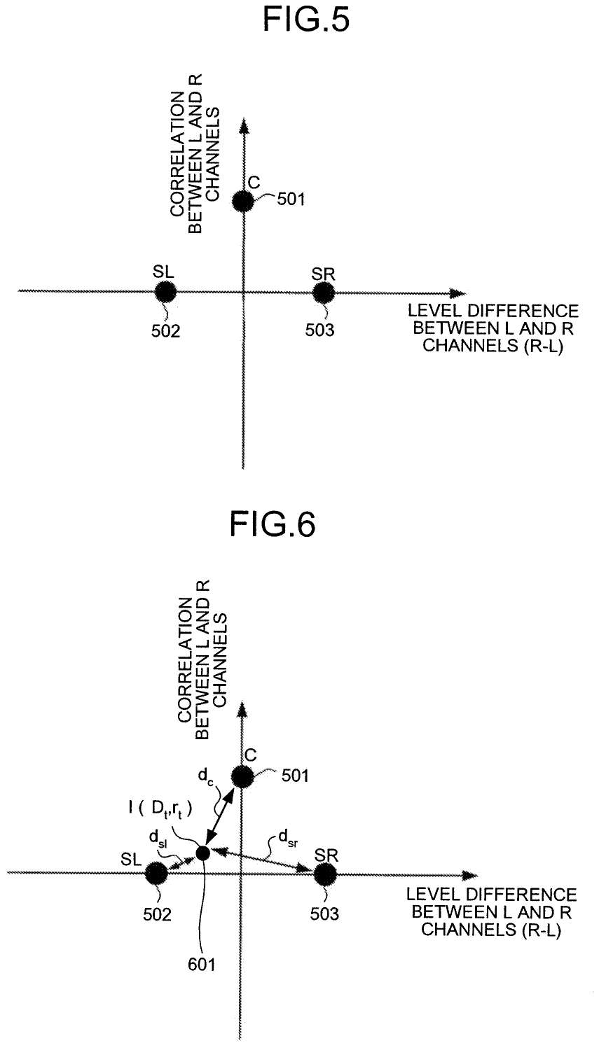

FIG. 5 is an explanatory diagram of positions of the center signal and the surround signals on the two-dimensional plane. The center signal (Cₜout) and the surround signals (SRₜout and SLₜout) are arranged on the two-dimensional plane based on the properties of the surround signals generated by the surround-component generating unit 303. In other words, each surround signal is arranged adjacent to a point 501 corresponding to a coordinate C(D_{c}, r_{c}), a point 502 corresponding to a coordinate SL(Dₛₜ, rₛₜ), and a point 503 corresponding to a coordinate SR(Dₛᵣ, rₛᵣ).

The coordinates are arranged in this way since the center signal is positioned at the center and hence, 1) a level difference between the L and the R channels does not occur, and 2) the correlation between the L and the R channels is high. Another reason is that the surround components have low correlations with the L and the R channels.

Therefore, the surround-component generating unit 303 can generate more natural sounding surround components causing no discomfort by respectively allocating the input signals to the surround components based on a positional relationship between the point I(Dₜ, rₜ) mapped above and each of the points, the point 501 of C, the point 502 of SL, and the point 503 of SR. As a method of the allocation, the input signals can be allocated only to the point most adjacent to the I (Dₜ, rₜ). Alternatively, the input signals may be allocated based on each distance between the point I(Dₜ, rₜ) and the each of the points C, SL and SR to obtain more natural output. For example, the closer to the point I(Dₜ, rₜ) one of C, SR, and SL is, the larger a coefficient may be assigned thereto to generate the surround signals.

FIG. 6 is an explanatory diagram in a case in which each mapped point is arranged on the two-dimensional plane. An output signal corresponding to a point 601 shown in FIG. 6 is calculated using the points 501 to 503 shown in FIG. 5. On this plane, a distance between the point 601 of I(Dₜ, rₜ) and the point 501 of C, a distance between the point 601 of I(Dₜ, rₜ) and the point 502 of SL, and a distance between the point 601 of I(Dₜ, rₜ) and the point 503 of SR are respectively represented by d_{c}, dₛₗ, and dₛᵣ (where in this case, dₛₗ<d_{c}<dₛᵣ). The output signals Cₜout, SRₜout, and SLₜout corresponding to the point 601 can be generated using coefficients W_{c}, Wₛᵣ, and Wₛₗ (where in this case, Wₛᵣ<W_{c}<Wₛₗ).

### [Equation 5]

Cₜout=W_{c}×(Lₜ+Rₜ)

SRₜout=Wₛᵣ×Rₜ (5)

SRₜout=Wₛₗ×Lₜ

Furthermore, proper normalization processing may be performed for level variations of the output signals of corresponding channels to adjust the level balance of the channels. The 5.1-channel signals can be generated from the two-channel signals by performing the above processing at the time interval.

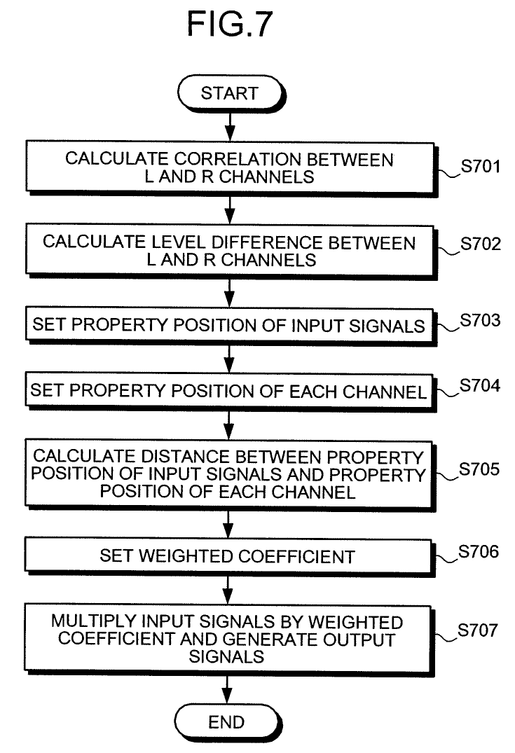

FIG. 7 is a flowchart of a process of generating surround signals based on the correlation value and the level difference. The process of the example starts upon input of the signals through the L and the R channels. The correlation-value calculating unit 301 calculates a correlation value between the L and the R channels (step S701). The level-difference calculating unit 302 calculates a level difference between the L and the R channels (step S702). The surround-sound generating unit 303 sets property positions of the input signals based on the calculated correlation value and the calculated level difference (step S703).

Each property position of the channels (C, SL, and SR in this case) are set (step S704). A distance between the property position of the input signals and each property position of the channels is calculated (step S705). The surround-component generating unit 303 sets weighted-coefficients based on the calculated distances (step S706). An output signal is generated by multiplying the input signals (the Lch and Rch channel input signals that have been added) by the weighted-coefficients (step S707), and a series of processing ends.

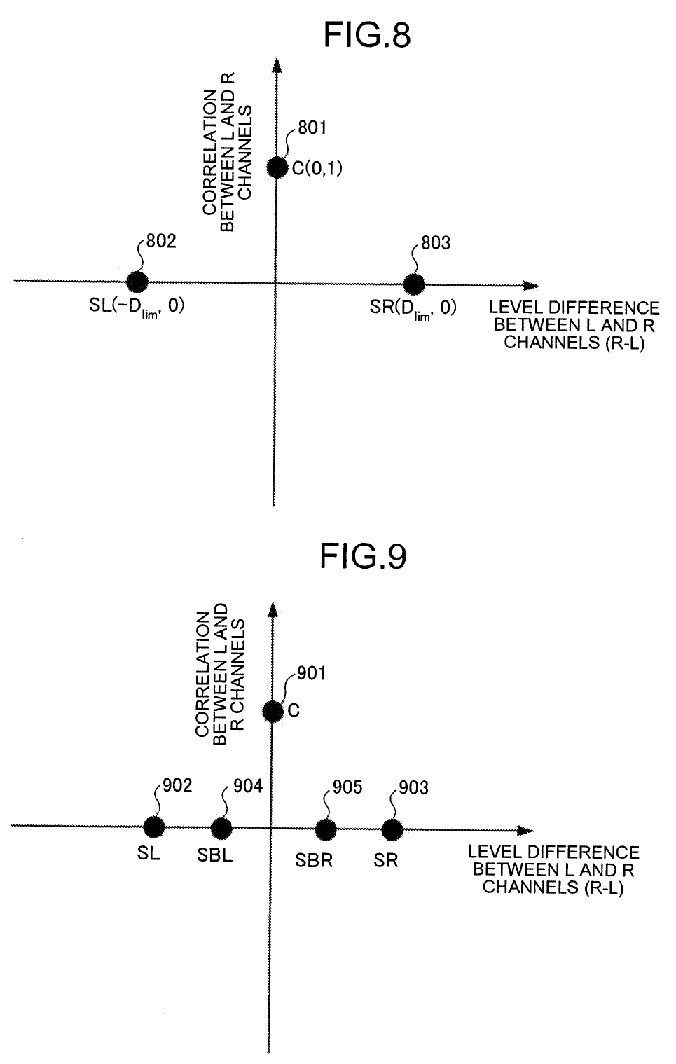

FIG. 8 is an explanatory diagram of each position of surround channels on a coordinate system. The horizontal axis and the vertical axis respectively represent the level difference and the correlation value that are parameters having different units. Three points C, SL, and SR are set to C(0, 1) represented by a point 801, SL (−D_{lim′} 0) represented by a point 802, and SR (D_{lim′} 0) represented by a point 803, respectively.

Next, a distance calculation is explained. Firstly, the point I(Dₜ, rₜ) is calculated based on the input signals. When an absolute value of Dₜ is significantly larger than the values of the three coordinates represented by the points 801 to 803, all distances between the point I(Dₜ, rₜ) and the three points become large, thereby being disadvantageous in the following calculation. Therefore, the absolute value must be converged to a certain point.

Specifically, when Dₜ>Dₗᵢₘ, Dₜ=Dₗᵢₘ is set. Similarly, when Dₜ<−Dₗᵢₘ, Dₜ=−Dₗᵢₘ is set As a result, even when the value of Dₜ becomes very large, the following calculation can be performed without difficulty. Since the correlation value is a finite value from −1 to 1, −1 and 1 are set to be the convergent points.

When the distance value is used for the distance calculation, the level difference becomes dominant since the level difference is larger than the correlation value. Therefore, a method of normalizing both of the values by multiplying a value along the vertical axis by the value of the convergent point of the level difference is considered, for example. Alternately, the dominant region can be removed by estimation based on the Mahalanobis distance.

For example, regarding the distances between the point I and each of the points C, SL, and SR, since a range of the value of Dₜ is −Dₗᵢₘ ≦Dₜ≦Dₗᵢₘ, while a range of the value of rₜ is −1≦rₜ≦1, the distance along the vertical axis is multiplied by Dₗᵢₘ to match the scales of the both values. In other words, when the distances between the point I and each of the points C, SL, and SR are respectively d_{c}, dₛₗ, and dₛᵣ, these values can be expressed by the following equations (6) to (8).
[Equation 6]

d_{c}\sqrt{(Dₜ−0)²+{Dₗᵢₘ(rₜ−1)}²} (6)
[Equation 7]

dₜ={square root over ((Dₜ−(−Dₗᵢₘ))²+{Dₗᵢₘ(rₜ−0)}²)} (7)
[Equation 8]

dₛᵣ=\sqrt{(Dₜ−Dₗᵢₘ)²+{Dₗᵢₘ(rₜ−0)}²} (8)

Next, weighted-coefficient calculation is explained. The weighted coefficients W_{c}, Wₛₗ, and Wₛᵣ are calculated from d_{c}, dₛₗ, and dₛᵣ. The smaller the values of d_{c}, dₛₗ, and dₛᵣ are, the larger values set to the weighted coefficients W_{c}, Wₛₗ, and Wₛᵣ are. Therefore, an equation to obtain W is defined as W=a^{d}, where 0<a<1. According to this equation, since W=1 when d=0, and the value of W is monotone decreasing as the value of d increases, the above condition is met. Lastly, W is normalized such that W_{c}+Wₛₗ+Wₛᵣ=1 to be the weighted coefficients.

FIG. 9 is an explanatory diagram of application to 7.1-channels. Although the case in which the points C, SL, and SR are included is explained in FIG. 8, in the case of FIG. 9, the output signals are calculated by adding more property points besides a point C 901, SL 902, and SR 903. In other words, a point 904 of SBL (surround back L) and a point 905 of SBR (surround back R) are added on the plane. As a result, a 7.1-channel sound or other multi-channel sound can be generated. For example, in the case of generating 7.1-channel sound, each property position of the channels is set, and the similar process is performed.

When generating 5.1-channel signals, L and R signals can be newly generated. In this case, considering the audio property, the L and the R signals are designated on a two-dimensional plane, and a similar algorithm for generating the points C, SR, and SL can be applied to generate the L and R signals. Furthermore, the same can apply to the LFE signal. The positions of each of the components on the plane are not limited to the positions shown in FIG. 9, various positions may be set and used. Furthermore, the positions may be set preliminarily or after consideration of distribution on the plane over the overall time interval. Moreover, axes of the two-dimensional plane are not limited to the axes shown in FIG. 9.

According to the above configuration, since the L and the R signals can be also generated, signals achieving a richer surround sound experience can be generated. Furthermore, since the axes can be freely selected, various audio properties can be used for generating the surround components. Moreover, appropriately corresponding to a source, a proper surround component can be generated by flexibly setting each position of the surround components instead of fixing the positions.

The basic configuration of the signal processing apparatus explained above can be classified into following three categories. One is the first-audio-parameter calculating unit 101 that calculates a correlation value based on two input signals, such as the correlation-value calculating unit 301. Another is the second-audio-parameter calculating unit 102 that calculates a level difference based on the two input signals, such as the level-difference calculating unit 302. Another is the surround-sound generating unit 303 that generates surround signals based on the calculated correlation value and the calculated level difference. The surround-component generating unit 303 can output all of the signals required for implementing the surround sound in principle, and select the optimal number of the output signals, if necessary.

According to the signal processing apparatus, two-channel signals recorded in a CD, etc are converted into multi-channel (for example, 5.1-channel) signals. As a result, multi-channel playback of the signals recorded in the CD, etc, can be enabled, and audio achieving a richer surround sound experience than that of the conventional method can be appreciated.

Furthermore, since the two-channel signals are converted into the surround signals with consideration of audio properties, which have not been considered conventionally, more naturally sounding surround signals can be generated. Moreover, the signal processing apparatus can be applied to a car navigation system, an HDD recorder, a DVD recorder (player), and various audio playback apparatus (including a car audio device).

The signal processing method explained in the present embodiment can be implemented by a computer such as a personal computer and a workstation executing a program that is prepared in advance. This program is recorded on a computer-readable recording medium such as a hard disk, a flexible disk, a CD-ROM, an MO, and a DVD, and is executed by being read out from the recording medium by a computer. This program can be a transmission medium that can be distributed through a network such as the Internet.

1-10. (canceled)

11. A signal processing apparatus comprising:
a first-audio-parameter calculating unit that calculates, as a first audio parameter, a correlation value between two audio signals;
a second-audio-parameter calculating unit that calculates, as a second audio parameter, a level difference between the two audio signals; and
a surround-signal generating unit that generates, based on a correlation between the first audio parameter and the second audio parameter, a plurality of surround components respectively allocated as a plurality of surround signals.

12. The signal processing apparatus according to claim 11, wherein the second-audio-parameter calculating unit calculates an average level, respectively, for the two audio signals for each time-window divided section thereof, as the level difference.

13. The signal processing apparatus according to claim 11, wherein the first-audio-parameter calculating unit and the second-audio-parameter calculating unit calculate the first audio parameter and the second audio parameter, respectively, for each time-window divided section of the two audio signals.

14. The signal processing apparatus according to claim 11, wherein the surround-signal generating unit generates the surround components based on a distance between a point representing values of the first audio parameter and the second audio parameter and plotted on a two-dimensional coordinate system formed by orthogonal axes representing the first audio parameter and the second audio parameter and a plurality of property points respectively corresponding to a channel and plotted on the two-dimensional coordinate system.

15. The signal processing apparatus according to claim 11, wherein the surround-signal generating unit generates, as the surround components, two surround signals and a center signal.

16. The signal processing apparatus according to claim 11, further comprising an output unit that outputs a low frequency signal from a signal resulting from addition of the two audio signals.

17. A signal processing method comprising:
calculating, as a first audio parameter, a correlation value between two audio signals;
calculating, as a second audio parameter, a level difference between the two audio signals; and
generating, based on a correlation between the first audio parameter and the second audio parameter, a plurality of surround components respectively allocated as a plurality of surround signals.

18. The signal processing method according to claim 17, wherein the calculating the second-audio-parameter includes calculating an average level, respectively, for the two audio signals for each time-window divided section thereof, as the level difference.

19. The signal processing method according to claim 17, wherein the calculating the first-audio-parameter and the second-audio-parameter include calculating the first audio parameter and the second audio parameter, respectively, for each time-window divided section of the two audio signals.

20. The signal processing method according to claim 17, wherein the generating includes generating the surround components based on a distance between a point representing values of the first audio parameter and the second audio parameter and plotted on a two-dimensional coordinate system formed by orthogonal axes representing the first audio parameter and the second audio parameter and a plurality of property points respectively corresponding to a channel and plotted on the two-dimensional coordinate system.

21. The signal processing method according to claim 17, wherein the generating includes generating, as the surround components, two surround signals and a center signal.

22. The signal processing method according to claim 17 further comprising outputting a low frequency signal from a signal resulting from addition of the two audio signals.

23. A computer-readable recording medium that stores therein the signal processing program causing a computer to execute:
calculating, as a first audio parameter, a correlation value between two audio signals;
calculating, as a second audio parameter, a level difference between the two audio signals; and
generating, based on a correlation between the first audio parameter and the second audio parameter, a plurality of surround components respectively allocated as a plurality of surround signals.

24. The computer-readable recording medium according to claim 23, wherein the calculating the second-audio-parameter includes calculating an average level, respectively, for the two audio signals for each time-window divided section thereof, as the level difference.

25. The computer-readable recording medium according to claim 23, wherein the calculating the first-audio-parameter and the second-audio-parameter include calculating the first audio parameter and the second audio parameter, respectively, for each time-window divided section of the two audio signals.

26. The computer-readable recording medium according to claim 23, wherein the generating includes generating the surround components based on a distance between a point representing values of the first audio parameter and the second audio parameter and plotted on a two-dimensional coordinate system formed by orthogonal axes representing the first audio parameter and the second audio parameter and a plurality of property points respectively corresponding to a channel and plotted on the two-dimensional coordinate system.

27. The computer-readable recording medium according to claim 23, wherein the generating includes generating, as the surround components, two surround signals and a center signal.

28. The computer-readable recording medium according to claim 23, further comprising outputting a low frequency signal from a signal resulting from addition of the two audio signals.
